(19) United States
(12) Patent Application Publication
(10) Pub. No.: US 2017/0129115 A1
(43) Pub. Date: May 11, 2017

(54) Shaving Unit with Blade Cleaning Apparatus

(71) Applicant: ShaVohn Curley, Disputanta, VA (US)

(72) Inventor: ShaVohn Curley, Disputanta, VA (US)

(21) Appl. No.: 15/347,778

(22) Filed: Nov. 9, 2016

Related U.S. Application Data
(60) Provisional application No. 62/252,634, filed on Nov. 9, 2015.

(51) Int. Cl. B26B 21/40

(52) U.S. Cl. CPC B26B 21/4062; B26B 21/4012

(57) ABSTRACT

A shaving unit that includes a blade assembly, a handle assembly, and a push rod. The blade assembly includes a housing portion and two blades attached to interior walls of the housing portion. The blades being latitudinally aligned, longitudinally displaced, and having a spatial separation between the two blades. The handle assembly is attached to the housing portion of the blade assembly and includes an internal cavity. The shaving unit further includes a push rod positioned within the internal cavity of the handle assembly. The push rod includes a blunted end directly in contact with one of the two razor blades and an actuator button on an opposite end. The push rod is capable of being moved forward and backwards when actuated in either direction and when actuated in the forward direction causes the blade directly in contact with to increase the spacial separation between blades.

### CROSS REFERENCE TO RELATED APPLICATION

This application claims priority to U.S. Provisional Patent Application No. 62/252,634 filed Nov. 9, 2015 and entitled “Shave and Go Razors,” the entire contents of which are hereby fully incorporated herein by reference.

### TECHNICAL FIELD

The present invention relates generally to a shaving blade unit having a handle and razor blade assembly comprising two cutting blades and, more particularly, to a shaving blade unit having a push rod communicable coupled directly with one cutting blade and an actuator positioned within the handle, the actuator actionable to cause the push rod to move a cutting blade in a manner so that the razor blade assembly can be cleaned.

### BACKGROUND

The art is replete with use of twin-blade, wet-shaving razor units, and use of disposable razors and cartridges, have become quite common. The blades in these razor units are fixedly spaced apart from one another to create desired blade geometry. During shaving, various forms of debris, e.g., cut whiskers, shaving cream, soap, etc., can become lodged within the space between the blades. Because such shaving debris may detract from the effectiveness of the shave, various mechanisms have been suggested for removing the debris from this space during and/or after shaving. In particular, the rigid, twin-blade, wet-shaving units of the prior art are typically designed with four securing posts that pass through the blades and connect a cap portion to a seat portion. Because these razor units are of a rigid design, the use of four securing posts is sufficient to maintain the components of the razor unit in the desired blade geometry during shaving. At the same time, the use of only four securing posts leaves the central portion of the razor unit free to accept a cleaning mechanism.

A common problem encountered by wet safety razors is the accumulation of shaving debris between skin-engaging elements of the razor head. In recent times, most safety razors sold on the market are manufactured with two blades disposed in spaced relation. Typically, a guard member is positioned forwardly of the leading blade at a fixed distance from the leading blade in order to control the angle at which the skin surface being shaved contacts the leading blade. The size of the space between the two blades will also affect the flow of skin over the cutting edges and, therefore, needs to be carefully controlled during the manufacture of the razor head. The accumulation of whiskers, soap, skin cells and other shaving debris in any of these small spaces poses the potential for altering the flow of skin across the sharpened blade edges and adversely affecting the comfort and closeness of the shave.

Those skilled in the art will appreciate that shaving debris such as shaving aids, soap, hair, skin cells, etc., can adversely affect the operation of the razor mechanism which generally comprises movable elements, e.g., slidable levers, springs, etc., and thus can affect the ability of the shaving system to operate as intended. Some designs attempt to protect razor mechanisms from shaving debris by enclosing the mechanism in a housing of the razor. To enhance proper functioning of the razor mechanism after extended exposure to shaving debris, greater clearances are required between the elements of razor mechanisms. Greater clearances lead to less control over the razor head and negatively influence the resulting shave. Attempts to better seal the razor mechanism within a housing of a razor have only been partially successful and have left small openings which allow shaving debris to contact and accumulate within the razor mechanism over time.

Various prior arts have disclosed hair extensions for example, U.S. Pat. Nos. 3,972,114, 4,047,296, 4,226,019, 4,205,437, and 4,344,227 disclose various cleaning mechanisms for removing the debris that becomes lodged between the blades of a twin-blade razor unit during shaving. However, these cleaning mechanisms were designed for use with rigid, twin-blade, wet-shaving razor units and, accordingly, are not suitable for use with the recently-introduced, flexible, twin-blade, wet-shaving razor units.

For example, U.S. Pat. No. 3,972,114 discloses a cleaning mechanism having a “saw-like” configuration and which is positioned between the blades of a twin blade razor unit. During and/or after shaving, the cleaning mechanism is operated by moving it from side to side, i.e., in a direction parallel to the blade edge. This operation requires two hands—one to hold the razor unit and the other to operate the cleaning mechanism. It is stated in the patent that this action will dislodge the debris trapped between the blades during shaving.

Next, U.S. Pat. Nos. 4,226,019 and 4,047,296 both disclose rectangular-shaped cleaning mechanisms that surround a smaller rectangular-shaped spacer. Such a design is disadvantageous when employed with flexible razor units because the rectangular spacer (having securing pins passing there through) significantly reduces, if not eliminates, the flexibility of such unit. As is well-known in the art, the linear distance between the ends of a flexible razor unit decreases as the unit is flexed. The design of the spacers in the above-mentioned references would limit or, not allow, the individual components of the razor units to move transversely with respect to one another as the units are flexed. Additionally, the design provides a less desirable means of biasing the ejector bar to the retracted position.

Of the prior art references mentioned above, the cleaning mechanism disclosed in various cited patent references disclose various cleaning mechanisms providing less desirable designs.

The foregoing patents reflect the state of the art of which the applicant is aware and are tendered with the view toward discharging applicant's acknowledged duty of candor in disclosing information which may be pertinent in the examination of this application. It is respectfully stipulated, however, that none of these patents teach or render obvious, singly or when considered in combination, applicant's claimed invention.

It is therefore highly desirable to provide a mechanism for the selective removable of shaving debris from spaces defined by skin-engaging elements of a razor head. It is also highly desirable to provide a simple design with a minimum number of pieces in order to facilitate quick and inexpensive manufacture of the subject razor head. Specifically, it would be desirable to eliminate the need for separate forming biasing members intended to return movable skin-engaging elements to their original positions after the blades are cleaned and also when shaving forces are removed.

### SUMMARY

The present invention overcomes the disadvantages of the prior art by providing a shaving blade unit having a handle and razor blade assembly comprising two cutting blades and a push rod positioned within the handle and communicable coupled directly with one of the cutting blades wherein the push rod can be acted upon so as to cause the push rod to move one of the cutting blades in a manner so that the razor blade assembly can be cleaned.

According to this invention, the shaving unit includes a blade assembly that includes a housing portion housing two blades. The housing portion includes a bottom surface section with an aperture that expose the two blades, the two blades latitudinally displaced and longitudinally aligned, and spatially separated. The housing portion further includes a sidewall section surrounding and continuing the bottom surface section, and a top section surrounding and continuing the sidewall section. The formed sections forming a hollow section where the two blades are fixed to an interior wall or walls of the housing section. Further to this invention, the shaving unit includes a handle assembly that includes an end section, and a sidewall section surrounding and continuing the end section forming an internal cavity. An opposite end of the sidewall section being physically attached with the housing portion. The sidewall section further including an aperture along a section of the sidewall portion. Further to this invention, the shaving unit includes a push rod positioned within the internal cavity of the handle assembly. The push rod including a blunted end directly in contact with one of the two razor blades and an actuator button on an opposite end. The actuator button positionable within the aperture opening along the sidewall portion of the handle assembly. The push rod capable of being moved forward and backwards when actuated in either direction and when actuated in the forward direction causes the blade directly in contact with to increase the spacial separation between blades.

### BRIEF DESCRIPTION OF THE DRAWINGS

FIG. 1 is a bottom view of a shaving unit having two cutting units, according to an embodiment of the invention.

FIG. 2A is a top, cut away view of the shaving unit, according to an embodiment of the invention.

FIG. 2B is another top, cut away view of the shaving unit, according to an embodiment of the invention.

### DETAILED DESCRIPTION

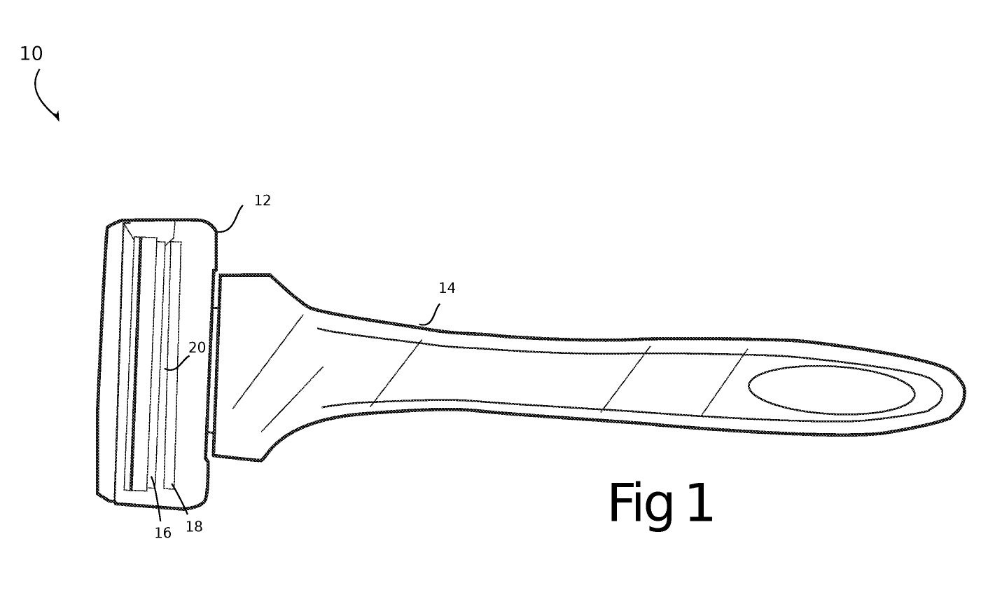

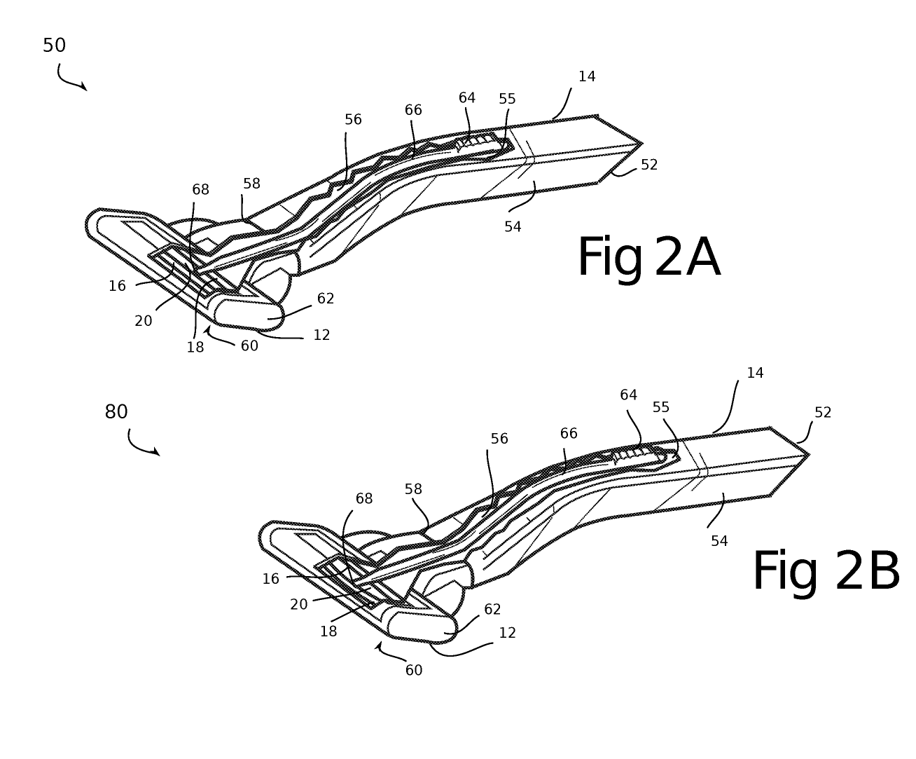

Referring to FIG. 1, shaving unit 10 represents a twin-blade shaving unit that includes a blade assembly 12, a handle assembly 14 attached thereto, and a first and second blade 16,18 housed within the housing assembly 12. The blades 16,18 are stacked in parallel may be longitudinally aligned but latitudinally displaced. Stated more simply, the one blade 18 may be advanced more forward than the other blade 16. Sectislmckinnon10@aol.comon 20 represents the space where debris from shaving may become lodged and need to be removed by the cleaning means described. The blade assembly 12 and handle assembly 14 may be made from plastic using traditional plastic injection molding techniques. The blade assembly 12 and handle assembly 14 may be attached together during the manufacturing process. The blade assembly 12 and handle assembly 14 are formed in such a way that the assembly 12,14 includes a hollow interior space to accommodate a push rod mechanism communicable coupled directly to one of the blades 16,18 so as to be able to manipulate the blade in a manner favorable to cleaning and dislodging the debris lodged within section 20. This aspect of the invention will be described in more detail in reference to FIGS. 2 and 3. The blades 16,18 may be made of a steel that is flexible and elastic enough so that the blade after being manipulated by the push rod will return to its original position, or close enough thereto, to result in normal operation.

Referring now to FIGS. 2A and 2B, illustrated is a top, cut away view of shaving unit 10 denoted generally as 50 and 80, respectively. Shaving unit 50,80 represents the twin-blade shaving unit 10 that includes the blade assembly 12, the handle assembly 14 attached thereto, first and second blade 16,18 housed within the housing assembly 12, and push rod 52 in its normal resting position. Shaving unit 80 represents the twin-blade shaving unit 10 with the push rod 52 in its extended position so to push the blade into a position that causes enough spatial separation between the blades so that debris can be removed from section 20. In each case, the push rod 52 is communicable coupled directly with the one of the blades.

The shaving unit 50,80 includes a base section 52 and an upstanding sidewall portion 54 continuing and surrounding the base section 52 to form a hollow cavity 56. The sidewall section 54 includes opening 55 along a surface of the sidewall section. This opening may also include an o-ring gasket, plastic or rubber, secured to an inner section of the cavity 56. The rim of the sidewall section 54 opposite the base section 52 maybe attached with blade assembly 12 along section 58. The blade assembly 12 also include an interior section essentially congruently aligned with the hollow cavity 56. The blade assembly further includes a bottom section 60 with an opening or aperture section that exposes the two blades 16,18, a side section 62 surrounding and continuing the bottom section to form the aforementioned interior section for receiving the push rod 52. The push rod 52 includes a push button 64 positioned within opening 55 and and attached rod 66 that can be moved in a forward direction, toward the blade and returned to its normal position using the push button 64. End 68 of push rod is a blunted end that can rest securely with one of the blades. To maintain stability of the push rod within the unit, the plastic or rubber o-ring may be used in combination with the rod to secure the push rod 52 into place. For example, along the aperture Due to the flexibility and resiliency of the steel used for the blade, the shaving unit 50 can be manufactured simply with minimal parts, keeping in line with traditional manufacturing techniques of simple, cheap, disposable razors. The push rod 52 is an effective, reliable, and cost effective method of keeping the shaving unit 50 clean so that may be usable for a longer period of time.

Thus, While there have been shown and described and pointed out fundamental novel features of the invention as applied to a preferred embodiment thereof, it Will be under stood that various omissions and substitutions and changes in the form and details of the devices illustrated, and in their operation, may be made by those skilled in the art Without departing from the spirit of the invention. For example, it is expressly intended that all combinations of those elements and/or method steps Which perform substantially the same function in substantially the same Way to achieve the same results are Within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

1. A shaving unit comprising:
a blade assembly that includes a housing portion housing two blades, the housing portion including:
a bottom surface section with an aperture that expose the two blades, the two blades longitudinally aligned and latitudinally displaced, and spatially separated;
a sidewall section surrounding and continuing the bottom surface section;
a top section surrounding and continuing the sidewall section; and
the sections forming a hollow section where the two blades are fixed to an interior wall of the housing section;
a handle assembly that includes an end section, and a sidewall section surrounding and continuing the end section forming an internal cavity, an opposite end of the sidewall section physically attachable with the housing portion, the sidewall section further including an aperture along a section of the sidewall portion; and
a push rod positioned within the internal cavity of the handle assembly, the push rod including a blunted end directly in contact with one of the two razor blades and an actuator button on an opposite end, the actuator button positionable within the aperture opening along the sidewall portion of the handle assembly, the push rod capable of being moved forward and backwards when actuated in either direction and when actuated in the forward direction causes the blade directly in contact with to increase the spacial separation between blades.
